(19) United States
(12) Patent Application Publication
(10) Pub. No.: US 2022/0003371 A1
(43) Pub. Date: Jan. 6, 2022

(54) Simulated Three-Dimensional Flame Apparatus

(71) Applicant: Luminous Innovations, Inc., Portola Valley, CA (US)

(72) Inventor: Guangrun Sheng, Tokyo (JP)

(21) Appl. No.: 17/280,730

(22) PCT Filed: Nov. 28, 2019
(86) PCT No.: PCT/CN2019/121636

§ 371 Date: Mar. 26, 2021

(30) Foreign Application Priority Data
Sep. 29, 2018 (CN) 201821598484.4

(51) Int. Cl. F21S 10/04; B05B 17/08

(52) U.S. Cl. CPC F21S 10/043; B05B 17/08

(57) ABSTRACT

A simulated three-dimensional flame apparatus, comprising a base (1), a mist generation mechanism disposed in the base (1), and an outer cover (2) and a light emitting mechanism connected to the base (1). The inner cavity of the outer cover (2) is a mist accumulation chamber (3), a mist outlet (4) of the mist generation mechanism is in communication with the mist accumulation chamber (3), or a part that generates mist in the mist generation mechanism is disposed inside of the mist accumulation chamber (3). The top of the outer cover (2) is provided with a flame outlet (5). The light emitting mechanism is disposed inside of the outer cover (2) and the light emission direction thereof is toward the flame outlet (5), such that the light beam from the light emitting mechanism radiates on the mist emitted from the flame outlet (5), and the refraction of the light beam off the mist forms a dynamic flame (6). The light beam from the light source (17) radiates on the mist which is emitted irregularly, the light refracts off the mist and forms a dynamic flame (6), thereby presenting realistically the flickering effect of a burning flame.

### TECHNICAL FIELD

The present utility model relates to the field of simulated flame technology, more specifically, it relates to a simulated three-dimensional flame apparatus.

### BACKGROUND TECHNOLOGY

Candles or flame apparatus are decorative daily necessities and traditional candles or flame apparatus are mainly used for lighting, and this is achieved by burning wax oil. However, burning gradually shortens and uses up the wick of the candle or flame apparatus. As society develops, the function of candles or flame apparatus is no longer limited to lighting and also has decorative and ambience-enhancing effects. The flickering candlelight of a few lit candles or flame apparatus on birthday parties, gatherings with friends and dates with lovers can enhance the romantic atmosphere. However, traditional candles or flame apparatus produce flue gas and pollute the environment after they are lit, and the open flame also poses as a safety hazard. Therefore, traditional candles or flame apparatus are increasingly replaced by simulation candles or simulation flame apparatus. Simulation candles or simulation flame apparatus can simulate the effect of lit candles with light generated by a light source. Therefore, it is widely used in venues such as bars, cafes, and dance halls.

At present, simulation candles or simulation flame apparatus usually simulate flame by projecting light onto a flame sheet. This method restricts the angle of view and the diffusely reflected flame sheet carrier of electronic candles or that placed at the top of flame apparatus cause the simulation effect to be unreal, thereby making the degree of simulation low and the apparatus unrealistic.

### Summary of Utility Model

The purpose of the present utility model is to overcome disadvantages and shortcomings in prior art and provide a simulated three-dimensional flame apparatus. In the simulated three-dimensional flame apparatus, the light beam from the light source radiates on the mist which is emitted irregularly, the light refracts off the mist and forms a dynamic simulated three-dimensional flame, thereby presenting realistically the flickering effect of a burning flame. Another purpose of the present utility model is to provide a simulated three-dimensional flame apparatus that can resolve the problem of cyclic flow that is easily generated when the mist emitted is at a low position, which makes it difficult for the simulated three-dimensional flame to form, thereby further increasing the degree of simulation.

In order to achieve the above purpose, the present utility model shall be realized through the technical solutions below: A simulated three-dimensional flame apparatus, wherein: comprising a base, a mist generation mechanism disposed in the base, and an outer cover and a light emitting mechanism connected to the base; the inner cavity of the outer cover is a mist accumulation chamber, a mist outlet of the mist generation mechanism is in communication with the mist accumulation chamber, or a part that generates mist in the mist generation mechanism is disposed inside of the mist accumulation chamber; the top of the outer cover is provided with a flame outlet, the light emitting mechanism is disposed inside of the outer cover and the light emission direction thereof is toward the flame outlet, such that the light beam from the light emitting mechanism radiates on the mist emitted from the flame outlet, and the refraction of the light beam off the mist forms a dynamic flame.

In the above solution, the mist generated by the mist generation mechanism of the present utility model accumulates in the mist accumulation chamber and gushes out irregularly from the flame outlet at the top of the outer cover. At this time, the light beam from the light emitting mechanism radiates on the mist emitted from the flame outlet, and the refraction of the light beam off the mist forms a dynamic simulated three-dimensional flame. The flame formed this way does not have a restricted angle of view and the simulation effects are real and realistic, thereby presenting realistically the flickering effect of a burning flame.

Specifically, the present utility model further comprises a mist supply mechanism used to make the mist in the mist accumulation chamber rise rapidly to the flame outlet; the mist supply mechanism is disposed inside of the base and the air outlet of the mist supply mechanism is in communication with the mist accumulation chamber; or the mist supply mechanism is disposed inside of the mist accumulation chamber. The present utility model can adjust the performance of the mist supply mechanism in order to adjust the mist rising speed or the amount that rises to the flame outlet, thereby adjusting the size of the simulated three-dimensional flame.

The mist generation mechanism comprises a water storage tank disposed inside of the base, an atomization chamber and an atomization sheet; the atomization chamber is in communication with the water storage tank; the top of the atomization chamber is provided with an outlet for mist that is used as a mist outlet, and the mist outlet is in communication with the mist accumulation chamber; the atomization sheet is disposed at the bottom of the atomization chamber.

The atomization chamber is in communication with the water storage tank, which means that: further comprising a strainer, the atomization chamber is in communication with the water storage tank through a strainer; the top of the water storage tank is provided with a water injection port.

The atomization sheet is disposed at the bottom of the atomization chamber, which means that: a groove is set up at the bottom of the atomization chamber and the atomization sheet is installed in the groove; the water level in the atomization chamber is higher than the atomization sheet. The atomization sheet of the solution of the present utility model is disposed in water. Therefore, the atomization sheet must be fixed in position with the groove.

The mist supply mechanism is disposed inside of the base and the air outlet of the mist supply mechanism is in communication with the mist accumulation chamber, which means that: the mist supply mechanism comprises a ventilator, an air duct and an air inlet; the ventilator is disposed at the bottom of the base, one end of the air duct is connected to the ventilator and another end passes through the water storage tank, extends into the atomization chamber and is connected to the light emitting mechanism; the air outlet is disposed on the air duct in the atomization chamber; the air inlet is near the ventilator and set up on the wall of the base. When operating, the ventilator supplies wind into the mist accumulation chamber and causes mist to be emitted from the flame outlet irregularly under the effect of wind to present the flickering effect of a burning flame under the light emission by a light source. The mist rising speed or the amount that rises to the flame outlet can be adjusted through adjusting the air output of the ventilator, thereby adjusting the size of the simulated three-dimensional flame.

The second solution is: the mist generation mechanism comprises an atomization sheet disposed in the mist accumulation chamber, a water absorbing stick and a water storage tank disposed at the bottom of the base; one end of the water absorbing stick extends into the water storage tank and another end is connected to the atomization sheet.

The mist supply mechanism is disposed inside of the base and the air outlet of the mist supply mechanism is in communication with the mist accumulation chamber, which means that: the mist supply mechanism comprises a ventilator and an air inlet; the ventilator is disposed on top of the water storage tank and the vent of the ventilator is used as an air outlet and is in communication with the mist accumulation chamber; the air inlet is near the ventilator and set up on the wall of the base. The mist rising speed or the amount that rises to the flame outlet can be adjusted through adjusting the air output of the ventilator, thereby adjusting the size of the simulated three-dimensional flame.

The light emitting mechanism comprises a light source and an inner barrel cover used to converge light beams from the light source; the top opening of the inner barrel cover is opposite the flame outlet, and the top opening of the inner barrel cover forms a gap with the flame outlet, such that the mist in the mist accumulation chamber is emitted from the flame outlet irregularly through the gap; the light source is disposed inside of the inner barrel cover and the light beam from the light source radiates on the flame outlet along the top opening of the inner barrel cover.

The present utility model further comprises an electric control board connected to the light emitting mechanism and mist generation mechanism; the electric control board is disposed inside of the base.

The present utility model further comprises an outer shell: the outer shell encases the outer cover; the top opening of the outer shell is opposite the flame outlet and a housing space in communication with the top opening of the outer shell is provided between the outer shell and the outer cover.

The present utility model further comprises a mist supply and cyclic flow prevention mechanism used to make mist in the mist accumulation chamber rise rapidly to the flame outlet and prevent cyclic flow that is generated when the mist emitted from the flame outlet is at a low position; the mist supply and cyclic flow prevention mechanism is disposed in the housing space between the outer shell and outer cover and the air outlet of the mist supply and cyclic flow prevention mechanism is in communication with the mist accumulation chamber and housing space.

The mist supply and cyclic flow prevention mechanism of the present utility model has two functions:

Function 1: When operating, the mist supply and cyclic flow prevention mechanism supplies part of the wind into the mist accumulation chamber and causes mist to be emitted from the flame outlet irregularly under the effect of wind to present the flickering effect of a burning flame under the light emission by the light emitting mechanism. Moreover, the mist rising speed or the amount that rises to the flame outlet can be adjusted through adjusting the air output, thereby adjusting the size of the simulated three-dimensional flame.

Function 2: The air outlet of the mist supply and cyclic flow prevention mechanism, housing space and top opening of the outer shell are in communication with each other. The mist supply and cyclic flow prevention mechanism supplies wind into the housing space, creates air flow from the top opening of the outer shell, and enters the housing space from the air inlet to form a cyclic flow. The air flow created brings the mist emitted from the flame outlet upwards and the air flow from the top opening of the outer shell surrounds the mist emitted, resolving the problem of cyclic flow that is easily generated when the mist emitted is at a low position (i.e. 1-8 cm away from the flame outlet), which makes it difficult for the simulated three-dimensional flame to form, thereby further increasing the degree of simulation of the flame and making it more realistic.

Specifically, the mist supply and cyclic flow prevention mechanism has two structural solutions:

The first structural solution is: the mist supply and cyclic flow prevention mechanism comprises a fan, an air inlet, an air outlet of the inner cavity that is in communication with the mist accumulation chamber and an air duct in communication with the housing space; the fan is disposed in the housing space between the outer shell and outer cover and the air outlet thereof is in communication with the air outlet of the inner cavity and the air duct, respectively; the air inlet is near the fan and set up on the wall of the outer shell.

The second structural solution is: the mist supply and cyclic flow prevention mechanism comprises mist supply components and cyclic flow prevention components; the mist supply components comprise a fan I, an air inlet, and an air outlet of the inner cavity that is in communication with the mist accumulation chamber; the fan I is disposed in the housing space and the air outlet thereof is in communication with the air outlet of the inner cavity; the air inlet is near fan I and set up on the wall of the outer shell;

The cyclic flow prevention components comprise a fan II disposed in the housing space; the air outlet of the fan II faces upwards.

The mist generation mechanism comprises an atomization sheet disposed in the mist accumulation chamber, a water absorbing stick and a water storage tank disposed at the bottom of the base; one end of the water absorbing stick extends into the water storage tank and another end is connected to the atomization sheet.

The light emitting mechanism is a light source disposed at the side of the flame outlet. When operating, the light beam from the light source at the side radiates on the mist emitted from the flame outlet.

The light source is two or more multi-colored light sources that emit light in a color-changing manner. When operating, the color-changing light beam emitted from the light sources radiates on the mist emitted from the flame outlet.

The light source is two or more light sources that emit light by alternating light and dark. When operating, the light beam alternating light and dark that is emitted from the light sources radiate on the mist emitted from the flame outlet.

The present utility model further comprises an electric control board provided with a power supply; the electric control board is connected to the light emitting mechanism and mist generation mechanism, respectively.

The present utility model further comprises a power socket and push button switch; the power socket and push button switch are connected to the electric control board, respectively.

The features of the present utility model are:

1. The mist generation mechanism of the present utility model uses an atomization sheet connected to a water absorbent stick and water storage tank to form mist and simplify the internal structure and reduce the size of the apparatus.

2. The present utility model is disposed with a mist supply and cyclic flow prevention mechanism that is in communication with the mist accumulation chamber and housing space, respectively to form dual air flow; the air flow formed in the mist accumulation chamber causes mist to be emitted from the flame outlet irregularly to present the flickering effect of a burning flame under the light emission by the light emitting mechanism; the air flow formed in the housing space blows out from the top opening of the outer shell and surrounds the mist emitted, so that the mist flame emitted is not easily interfered and affected by external air flow, increasing the stability of the mist emitted and effectively resolving the problem of cyclic flow that is easily generated when the mist emitted is at a low position (i.e. 1-8 cm away from the flame outlet), which makes it difficult for the simulated three-dimensional flame to form, thereby further increasing the degree of simulation of the flame and making it more realistic.

3. The light source of the present utility model is disposed at the side of the flame outlet and directly radiates on the mist at the flame outlet to make the flame effect more prominent. In addition, the light source is a multi-colored light source and emits light in a color-changing manner, which increases the degree of simulation and three-dimensionality of the flame, making it more realistic. Alternatively, the light source emits light by alternating light and dark, causing the light and shadow projected on mist to have alternating light and dark changes, thereby forming the flickering effect of a flame.

As compared with prior art, the present utility model has the following advantages and beneficial effects:

1. In the simulated three-dimensional flame apparatus of the present utility model, the light beam from the light source radiates on the mist which is emitted irregularly, the light refracts off the mist and forms a dynamic simulated three-dimensional flame, thereby presenting realistically the flickering effect of a burning flame.

2. The simulated three-dimensional flame apparatus of the present utility model can resolve the problem of cyclic flow that is easily generated when the mist emitted is at a low position, which makes it difficult for the simulated three-dimensional flame to form, thereby further increasing the degree of simulation.

### DESCRIPTION OF DRAWINGS

FIG. 1 is a schematic diagram of the simulated three-dimensional flame apparatus in Embodiment 1;

FIG. 2 is a schematic diagram of the simulated three-dimensional flame apparatus in Embodiment 2;

FIG. 3 is a schematic diagram of the simulated three-dimensional flame apparatus in Embodiment 6;

FIG. 4 is a schematic diagram of the simulated three-dimensional flame apparatus in Embodiment 7;

wherein, 1 is the base, 2 is the outer cover, 3 is the mist accumulation chamber, 4 is the mist outlet, 5 is the flame outlet, 6 is the flame, 7 is the water storage tank, 8 is the atomization chamber, 9 is the ultrasonic atomization sheet, 10 is the electric control board, 11 is the strainer, 12 is the water injection port, 13 is the air outlet, 14 is the ventilator, 15 is the air duct, 16 is the air inlet, 17 is the light source, 18 is the inner barrel cover, 19 is the microporous atomization sheet, 20 is the water absorbing stick, 21 is the stand, 22 is the outer shell, 23 is the top opening, 24 is the housing space, 25 is the fan, 26 is the air outlet of the inner cavity, 27 is the power socket, 28 is the push button switch, 29 is the fan I and 30 is the fan II.

### SPECIFIC EMBODIMENTS

The present utility model shall be described in detail below with the drawings and specific embodiments.

### Embodiment 1

The atomization sheet in this embodiment uses an ultrasonic atomization sheet as an example to describe the following.

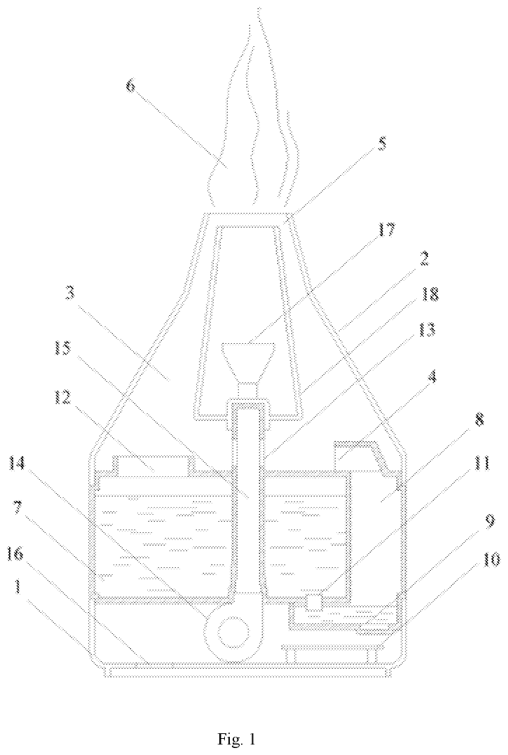

As shown in FIG. 1, the simulated three-dimensional flame apparatus of this embodiment comprises a base 1, a mist generation mechanism disposed in the base 1, and an outer cover 2 and a light emitting mechanism connected to the base 1, in which, the inner cavity of the outer cover 2 is a mist accumulation chamber 3, a mist outlet 4 of the mist generation mechanism is in communication with the mist accumulation chamber 3, the top of the outer cover 2 is provided with a flame outlet 5, the light emitting mechanism is disposed inside of the outer cover 2 and the light emission direction thereof is toward the flame outlet 5, and the light beam radiates from the flame outlet 5, such that the light beam from the light emitting mechanism radiates on the mist emitted from the flame outlet 5, and the refraction of the light beam off the mist forms a dynamic flame 6. This embodiment further comprises an electric control board 10 connected to the light emitting mechanism and mist generation mechanism, and the electric control board 10 is disposed at the bottom of the base 1.

The mist generation mechanism of this embodiment comprises a water storage tank 7 disposed inside of the base 1, an atomization chamber 8, an ultrasonic atomization sheet 9 and a strainer 11, in which, the atomization chamber 8 is located between the water storage tank 7 and the side wall of the base 1, and is in communication with the water storage tank 7 through the strainer 11, and the top of the water storage tank 7 is provided with a water injection port 12. The top of the atomization chamber 8 is provided with an outlet for mist that is used as a mist outlet 4, and the mist outlet is in communication with the mist accumulation chamber 3; the ultrasonic atomization sheet 9 is disposed at the bottom of the atomization chamber 8 and connected to the electric control board 10. Specifically: a groove is set up at the bottom of the atomization chamber 8 and the ultrasonic atomization sheet 9 is installed in the groove, and the water level in the atomization chamber 8 is higher than the ultrasonic atomization sheet 9.

This embodiment further comprises a mist supply mechanism to make mist in the mist accumulation chamber 3 rise rapidly to the flame outlet; the mist supply mechanism is disposed inside of the base 1 and the air outlet 13 of the mist supply mechanism is in communication with the mist accumulation chamber 3. The mist supply mechanism comprises a ventilator 14, an air duct 15 and an air inlet 16, in which, the ventilator 14 is disposed at the bottom of the base 1, one end of the air duct 15 is connected to the ventilator 14 and the other end passes through the water storage tank 7, extends into the atomization chamber 8 and is connected to the light emitting mechanism; the air outlet 13 is disposed on both sides of the air duct 15 in the atomization chamber 8 and the air inlet 16 is near the ventilator 14 and set up on the wall at the bottom of the base 1.

The light emitting mechanism of the present utility model comprises a light source 17 electrically connected to the electric control board 10 and an inner barrel cover 18 used to converge light beams from the light source; the inner barrel cover 18 gradually tapers in the direction of the flame outlet 5, its top opening is opposite the flame outlet 5, and the top opening of the inner barrel cover 18 forms a gap with the flame outlet 5, such that the mist in the mist accumulation chamber is emitted from the flame outlet 5 irregularly through the gap. Moreover, the light source 17 is disposed inside of the inner barrel cover 18 and the light beam from the light source 17 radiates on the flame outlet 5 along the top opening of the inner barrel cover 18.

The mist generated by the mist generation mechanism of the present utility model accumulates in the mist accumulation chamber 3 and gushes out irregularly under the effect of the ventilator 14 from the flame outlet 5 at the top of the outer cover 2. At this time, the light beam from the light emitting mechanism radiates on the mist emitted from the flame outlet 5, and the refraction of the light beam off the mist forms a dynamic simulated three-dimensional flame 6. The simulated three-dimensional flame 6 formed this way does not have a restricted angle of view and the simulation effects are real and realistic, thereby presenting realistically the flickering effect of a burning flame 6.

The working principle of the ultrasonic atomization sheet 9 in this embodiment is as follows: install the piezoelectric ceramic sheet (commonly referred to as ultrasonic atomization sheet) in the groove filled with water at the bottom of the atomization chamber 8 and generate a drive voltage on the atomization sheet that is consistent with the resonant frequency of the atomization sheet with the drive control circuit on the electric control board 10, and the atomization sheet will produce oscillation energy. Oscillation energy propagates in water in a perpendicular direction along the surface of the atomization sheet and at an appropriate water depth, the water surface on the energy propagation axis converges and elevates into a water column. A large amount of small capillary waves are concentrated at the front of the water column, greatly reducing the surface tension of the elevated water surface and the water surface is split into many small regions by the wavelength of the capillary waves, with every region becoming independent microparticles that do not seem to adhere to each other, dissipating in air and forming the effect of mist.

The ultrasonic atomization sheet 9 and electric control board 10 in the present utility model are prior art and are existing mature products that can be purchased on the market.

### Embodiment 2

The atomization sheet in this embodiment uses a microporous atomization sheet as an example to describe the following.

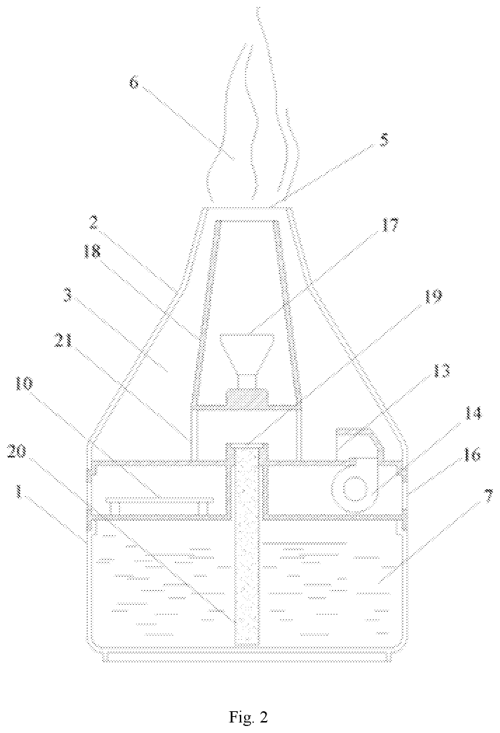

As shown in FIG. 2, the simulated three-dimensional flame apparatus of this embodiment comprises a base 1, a mist generation mechanism disposed in the base 1, and an outer cover 2 and a light emitting mechanism connected to the base 1, in which, the inner cavity of the outer cover 2 is a mist accumulation chamber 3, the part of the mist generation mechanism that generates mist is disposed inside of the mist accumulation chamber 3, the top of the outer cover 2 is provided with a flame outlet 5, the light emitting mechanism is disposed inside of the outer cover 2 and the light emission direction thereof is toward the flame outlet 5, and the light beam radiates from the flame outlet 5, such that the light beam from the light emitting mechanism radiates on the mist emitted from the flame outlet 5, and the refraction of the light beam off the mist forms a dynamic flame 6. This embodiment further comprises an electric control board 10 connected to the light emitting mechanism and mist generation mechanism, and the electric control board 10 is disposed inside of the base 1.

The mist generation mechanism of this embodiment comprises a microporous atomization sheet 19 disposed in the mist accumulation chamber 3, a water absorbing stick 20 and a water storage tank 7 disposed at the bottom of the base 1, in which, one end of the water absorbing stick 20 extends into the water storage tank 7 and another end is connected to the microporous atomization sheet 19.

The present utility model further comprises a mist supply mechanism to make the mist in the mist accumulation chamber 3 rise rapidly to the flame outlet; the mist supply mechanism is disposed inside of the base 1 and the air outlet 13 of the mist supply mechanism is in communication with the mist accumulation chamber 3. Among them, the mist supply mechanism comprises a ventilator 14 and an air inlet 16. The ventilator 14 is disposed on top of the water storage tank 7 and the vent of the ventilator 14 is used as an air outlet 13 and in communication with the mist accumulation chamber 3; the air inlet 16 is near the ventilator 14 and on the side wall of the base 1. The electric control board 10 is disposed at the top of the water storage tank 7.

The light emitting mechanism of the present utility model comprises a light source 17 electrically connected to the electric control board 10 and an inner barrel cover 18 used to converge light beams from the light source; the inner barrel cover 18 is erected on the end surface of the water storage tank 7 through the stand 21. At the same time, the inner barrel cover 18 gradually tapers in the direction of the flame outlet 5, its top opening is opposite the flame outlet 5, and the top opening of the inner barrel cover 18 forms a gap with the flame outlet 5, such that the mist in the mist accumulation chamber is emitted from the flame outlet 5 irregularly through the gap. Moreover, the light source 17 is disposed inside of the inner barrel cover 18 and the light beam from the light source 17 radiates on the flame outlet 5 along the top opening of the inner barrel cover 18.

The mist generated by the mist generation mechanism of the present utility model accumulates in the mist accumulation chamber 3 and gushes out irregularly under the effect of the ventilator 14 from the flame outlet 5 at the top of the outer cover 2. At this time, the light beam from the light emitting mechanism radiates on the mist emitted from the flame outlet 5, and the refraction of the light beam off the mist forms a dynamic simulated three-dimensional flame 6. The simulated three-dimensional flame 6 formed this way does not have a restricted angle of view and the simulation effects are real and realistic, thereby presenting realistically the flickering effect of a burning flame 6.

The working principle of the microporous atomization sheet 19 in this embodiment is as follows: as the frequency and working voltage of the microporous atomization sheet 19 are relatively low, it does not need to be put in water to work and mist is emitted from the micropores in the middle. First, secure the water absorbing stick 20 in the water storage tank 7, then secure the middle aperture of the microporous atomization sheet 19 on the water absorbing stick 20, and conduct electricity with the microporous atomization sheet circuit of the electric control board 10 to absorb water with the water absorbing stick 20, forming the effect of mist through the microporous atomization sheet 19.

The microporous atomization sheet 19 and electric control board 10 in the present utility model are prior art and are existing mature products that can be purchased on the market.

### Embodiment 3

The only difference between this Embodiment 3 and Embodiment 1 is: the mist supply mechanism is disposed inside of the mist accumulation chamber. When operating, the mist in the mist accumulation chamber is emitted from the flame outlet irregularly to present the flickering effect of a burning flame under the light emission by the light source.

Other structures of this embodiment are consistent with Embodiment 1.

### Embodiment 4

The only difference between this Embodiment 4 and Embodiment 2 is: the mist supply mechanism is disposed inside of the mist accumulation chamber. When operating, the mist in the mist accumulation chamber is emitted from the flame outlet irregularly to present the flickering effect of a burning flame under the light emission by the light source.

Other structures of this embodiment are consistent with Embodiment 2.

### Embodiment 5

The simulated three-dimensional flame apparatus of this embodiment comprises a base, a mist generation mechanism disposed in the base, and an outer cover and a light emitting mechanism connected to the base; the inner cavity of the outer cover is a mist accumulation chamber, a mist outlet of the mist generation mechanism is in communication with the mist accumulation chamber, or a part that generates mist in the mist generation mechanism is disposed inside of the mist accumulation chamber, in which, the top of the outer cover is provided with a flame outlet, the light emitting mechanism is disposed inside of the outer cover and the light beam thereof radiates from the flame outlet, such that the light beam from the light emitting mechanism radiates on the mist emitted from the flame outlet, and the refraction of the light beam off the mist forms a dynamic flame.

### Embodiment 6

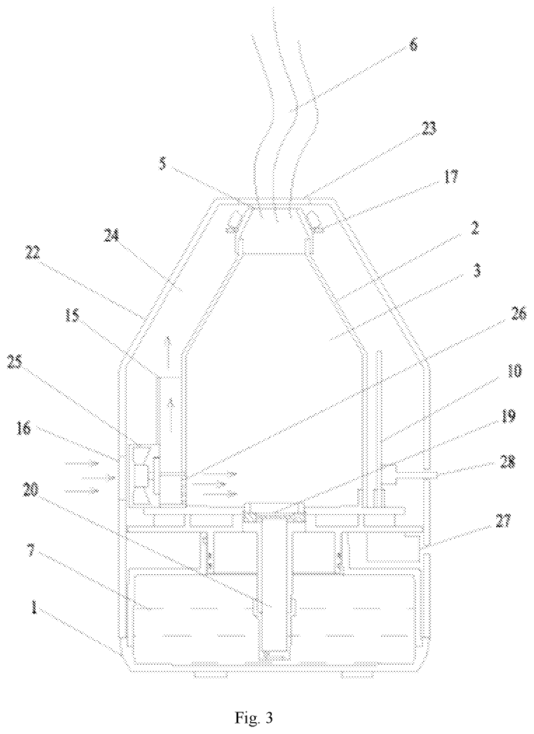

As shown in FIG. 3, the simulated three-dimensional flame apparatus of this embodiment comprises a base 1, a mist generation mechanism disposed in the base 1, and an outer cover 2 and a light emitting mechanism connected to the base 1, in which, the inner cavity of the outer cover 2 is a mist accumulation chamber 3, the part of the mist generation mechanism that generates mist is disposed inside of the mist accumulation chamber 3, the top of the outer cover 2 is provided with a flame outlet 5, the light emitting mechanism is disposed inside of the outer cover 2 and is a light source 17 located at both sides of the flame outlet 5, the light emission direction of the light source 17 is toward the flame outlet 5, and when operating, the light beam from the light source 17 at both sides radiates from the flame outlet 5, such that the light beam from the light emitting mechanism radiates on the mist emitted from the flame outlet 5, and the refraction of the light beam off the mist forms a dynamic flame 6.

The mist generation mechanism of this embodiment comprises a microporous atomization sheet 19 disposed in the mist accumulation chamber 3, a water absorbing stick 20 and a water storage tank 7 disposed at the bottom of the base 1, in which, one end of the water absorbing stick 20 extends into the water storage tank 7 and another end is connected to the microporous atomization sheet 19.

The present utility model further comprises an outer shell 22; the outer shell 22 encases the outer cover 2 and is connected to the base 1, the top opening 23 of the outer shell 22 is opposite the flame outlet 5 and a housing space 24 in communication with the top opening 23 of the outer cover is provided between the outer shell 22 and the outer cover 2. The present utility model further comprises a mist supply and cyclic flow prevention mechanism used to make mist in the mist accumulation chamber 3 rise rapidly to the flame outlet 5 and prevent cyclic flow that is generated when the mist emitted from the flame outlet 5 is at a low position; the mist supply and cyclic flow prevention mechanism is disposed in the housing space 24 between the outer shell 22 and outer cover 2 and the air outlet of the mist supply and cyclic flow prevention mechanism is in communication with the mist accumulation chamber 3 and housing space 24, in which, a low position refers to a distance of 1-8 cm from the flame outlet.

Specifically, the mist supply and cyclic flow prevention mechanism comprises a fan 25, an air inlet 16, an air outlet 26 of the inner cavity that is in communication with the mist accumulation chamber 3 and an air duct 15 in communication with the housing space 24; the fan 25 is disposed in the housing space 24 between the outer shell 22 and outer cover 2 and the air outlet thereof is in communication with the air outlet 26 of the inner cavity and the air duct 15, respectively; the air inlet 16 is near the fan 25 and set up on the wall of the outer shell 22.

The present utility model further comprises an electric control board 10 provided with a power supply; the electric control board 10 is disposed in the housing space 24 and connected to the light emitting mechanism and mist generation mechanism, respectively. This embodiment further comprises a power socket 27 and push button switch 28; both the power socket 27 and push button switch 28 are disposed inside of the outer shell 22 and connected to the electric control board, respectively.

The mist generated by the mist generation mechanism of the present utility model accumulates in the mist accumulation chamber 3 and gushes out irregularly under the effect of the fan 25 from the flame outlet 5 at the top of the outer cover 2. At this time, the light beam from the light emitting mechanism radiates on the mist emitted from the flame outlet 5, and the refraction of the light beam off the mist forms a dynamic simulated three-dimensional flame 6. The simulated three-dimensional flame 6 formed this way does not have a restricted angle of view and the simulation effects are real and realistic, thereby presenting realistically the flickering effect of a burning flame 6.

In addition, the fan 25 supplies a part of the wind into the housing space 24, creates air flow from the top opening 23 of the outer shell 22, and enters the housing space 24 from the air inlet 16 to form a cyclic flow. The air flow created brings the mist emitted from the flame outlet 5 upwards and the air flow from the top opening 23 of the outer shell 22 surrounds the mist emitted, resolving the problem of cyclic flow that is easily generated when the mist emitted is at a low position (i.e. 1-8 cm away from the flame outlet), which makes it difficult for the simulated three-dimensional flame to form, thereby further increasing the degree of simulation of the flame and making it more realistic.

The working principle of the microporous atomization sheet 19 in this embodiment is as follows: as the frequency and working voltage of the microporous atomization sheet 19 are relatively low, it does not need to be put in water to work and mist is emitted from the micropores in the middle. First, secure the water absorbing stick 20 in the water storage tank 7, then secure the middle aperture of the microporous atomization sheet 19 on the water absorbing stick 20, and conduct electricity with the microporous atomization sheet circuit of the electric control board 10 to absorb water with the water absorbing stick 20, forming the effect of mist through the microporous atomization sheet 19.

The microporous atomization sheet 19, electric control board 10, power socket 27 and push button switch 28 in the present utility model are prior art and are existing mature products that can be purchased on the market.

### Embodiment 7

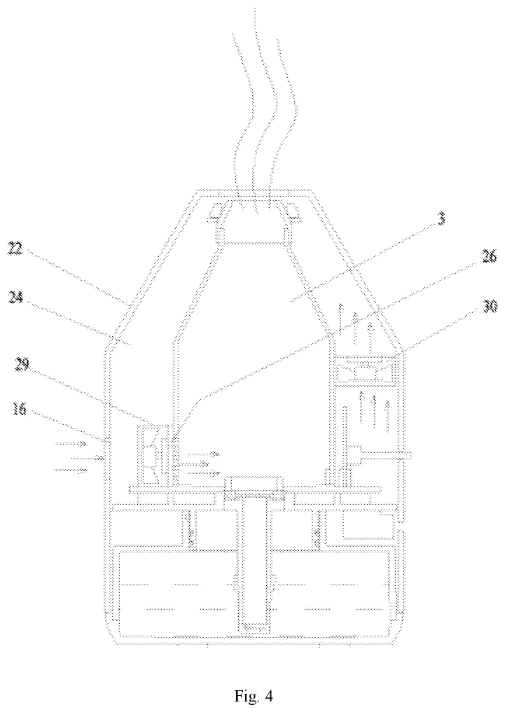

The difference between this embodiment and Embodiment 6 is: as shown in FIG. 4, the mist supply and cyclic flow prevention mechanism comprises mist supply components and cyclic flow prevention components, in which, the mist supply components comprise a fan I 29, an air inlet 16, and an air outlet 26 of the inner cavity that is in communication with the mist accumulation chamber 3; the fan I 29 is disposed in the housing space 24 and the air outlet thereof is in communication with the air outlet 26 of the inner cavity; the air inlet 16 is near fan I 29 and set up on the wall of the outer shell 22. The cyclic flow prevention component comprises a fan II 30 disposed in the housing space 24 and the air outlet of the fan II 30 faces upwards.

The mist generated by the mist generation mechanism of this embodiment accumulates in the mist accumulation chamber 3 and gushes out irregularly under the effect of the fan I 29 from the flame outlet 5 at the top of the outer cover 2. At this time, the light beam from the light emitting mechanism radiates on the mist emitted from the flame outlet 5, and the refraction of the light beam off the mist forms a dynamic simulated three-dimensional flame 6. The fan II 30 supplies wind into the housing space 24, creates air flow from the top opening 23 of the outer shell 22, and enters the housing space 24 from the air inlet 16 to form a cyclic flow. The air flow created brings the mist emitted from the flame outlet 5 upwards and the air flow from the top opening 23 of the outer shell 22 surrounds the mist emitted, resolving the problem of cyclic flow that is easily generated when the mist emitted is at a low position (i.e. 1-8 cm away from the flame outlet), which makes it difficult for the simulated three-dimensional flame to form, thereby further increasing the degree of simulation of the flame and making it more realistic.

Other structures of this embodiment are consistent with Embodiment 6.

### Embodiment 8

The difference between this embodiment and Embodiment 6 is: the light emitting mechanism is three or more light sources disposed at the side of the flame outlet. The light source is a multi-colored light source and emits light in a color-changing manner. When operating, the color-changing light beam emitted from the light sources radiates on the mist emitted from the flame outlet, which greatly increases the degree of simulation and three-dimensionality of the flame, making it more realistic.

Other structures of this embodiment are consistent with Embodiment 6.

### Embodiment 9

The difference between this embodiment and Embodiment 6 is: the light emitting mechanism is three or more light sources disposed at the side of the flame outlet. The light source emits light by alternating light and dark. When operating, the light beam alternating light and dark that is emitted from the light sources radiates on the mist emitted from the flame outlet, causing the light and shadow projected on mist to have alternating light and dark changes, thereby forming the flickering effect of a flame, which greatly increases the degree of simulation and three-dimensionality of the flame, making it more realistic.

Other structures of this embodiment are consistent with Embodiment 6.

The above embodiments are preferred embodiments of the present utility model. However, the embodiments of the present utility model are not limited to the above embodiments and other changes, modifications, substitutions, combinations and simplifications that do not deviate from the spirit of the present utility model in substance or principle should be equivalent replacement methods and are included in the scope of protection of the present utility model.

1. A simulated three-dimensional flame apparatus, wherein: comprising a base, a mist generation mechanism disposed in the base, and an outer cover and a light emitting mechanism connected to the base; the inner cavity of the outer cover is a mist accumulation chamber, a mist outlet of the mist generation mechanism is in communication with the mist accumulation chamber, or a part that generates mist in the mist generation mechanism is disposed inside of the mist accumulation chamber; the top of the outer cover is provided with a flame outlet, the light emitting mechanism is disposed inside of the outer cover and the light beam thereof radiates from the flame outlet, such that the light beam from the light emitting mechanism radiates on the mist emitted from the flame outlet, and the refraction of the light beam off the mist forms a dynamic flame.

2. The simulated three-dimensional flame apparatus according to claim 1, wherein: it further comprises a mist supply mechanism used to make the mist in the mist accumulation chamber rise rapidly to the flame outlet; the mist supply mechanism is disposed inside of the base and the air outlet of the mist supply mechanism is in communication with the mist accumulation chamber; or the mist supply mechanism is disposed inside of the mist accumulation chamber.

3. The simulated three-dimensional flame apparatus according to claim 2, wherein:
the mist generation mechanism comprises a water storage tank disposed inside of the base, an atomization chamber and an atomization sheet; the atomization chamber is in communication with the water storage tank; the top of the atomization chamber is provided with an outlet for mist that is used as a mist outlet, and the mist outlet is in communication with the mist accumulation chamber; the atomization sheet is disposed at the bottom of the atomization chamber;
The atomization chamber is in communication with the water storage tank, which means that: further comprising a strainer, the atomization chamber is in communication with the water storage tank through a strainer; the top of the water storage tank is provided with a water injection port;
The atomization sheet is disposed at the bottom of the atomization chamber, which means that: a groove is set up at the bottom of the atomization chamber and the atomization sheet is installed in the groove; the water level in the atomization chamber is higher than the atomization sheet;
The mist supply mechanism is disposed inside of the base and the air outlet of the mist supply mechanism is in communication with the mist accumulation chamber, which means that: the mist supply mechanism comprises a ventilator, an air duct and an air inlet; the ventilator is disposed at the bottom of the base, one end of the air duct is connected to the ventilator and another end passes through the water storage tank, extends into the mist accumulation chamber and is connected to the light emitting mechanism; the air outlet is disposed on the air duct in the atomization chamber; the air inlet is near the ventilator and set up on the wall of the base.

4. The simulated three-dimensional flame apparatus according to claim 2, wherein: the mist generation mechanism comprises an atomization sheet disposed in the mist accumulation chamber, a water absorbing stick and a water storage tank disposed at the bottom of the base; one end of the water absorbing stick extends into the water storage tank and another end is connected to the atomization sheet;
The mist supply mechanism is disposed inside of the base and the air outlet of the mist supply mechanism is in communication with the mist accumulation chamber, which means that: the mist supply mechanism comprises a ventilator and an air inlet; the ventilator is disposed on top of the water storage tank and the vent of the ventilator is used as an air outlet and is in communication with the mist accumulation chamber; the air inlet is near the ventilator and set up on the wall of the base.

5. The simulated three-dimensional flame apparatus according to claim 1, wherein: the light emitting mechanism comprises a light source and an inner barrel cover used to converge light beams from the light source; the top opening of the inner barrel cover is opposite the flame outlet, and the top opening of the inner barrel cover forms a gap with the flame outlet, such that the mist in the mist accumulation chamber is emitted from the flame outlet irregularly through the gap; the light source is disposed inside of the inner barrel cover and the light beam from the light source radiates on the flame outlet along the top opening of the inner barrel cover;
it further comprises an electric control board connected to the light emitting mechanism and mist generation mechanism: the electric control board is disposed inside of the base.

6. The simulated three-dimensional flame apparatus according to claim 1, wherein: it further comprises an outer shell; the outer shell encases the outer cover; the top opening of the outer shell is opposite the flame outlet and a housing space in communication with the top opening of the outer shell is provided between the outer shell and the outer cover.

7. The simulated three-dimensional flame apparatus according to claim 6, wherein: it further comprises a mist supply and cyclic flow prevention mechanism used to make mist in the mist accumulation chamber rise rapidly to the flame outlet and prevent cyclic flow that is generated when the mist emitted from the flame outlet is at a low position; the mist supply and cyclic flow prevention mechanism is disposed in the housing space between the outer shell and outer cover and the air outlet of the mist supply and cyclic flow prevention mechanism is in communication with the mist accumulation chamber and housing space.

8. The simulated three-dimensional flame apparatus according to claim 7, wherein: the mist supply and cyclic flow prevention mechanism comprises a fan, an air inlet, an air outlet of the inner cavity that is in communication with the mist accumulation chamber and an air duct in communication with the housing space; the fan is disposed in the housing space between the outer shell and outer cover and the air outlet thereof is in communication with the air outlet of the inner cavity and the air duct, respectively; the air inlet is near the fan and set up on the wall of the outer shell.

9. The simulated three-dimensional flame apparatus according to claim 7, wherein: the mist supply and cyclic flow prevention mechanism comprises mist supply components and cyclic flow prevention components; the mist supply components comprise a fan I, an air inlet, and an air outlet of the inner cavity that is in communication with the mist accumulation chamber; the fan I is disposed in the housing space and the air outlet thereof is in communication with the air outlet of the inner cavity; the air inlet is near the fan I and set up on the wall of the outer shell;
the cyclic flow prevention components comprise a fan II disposed in the housing space; the air outlet of the fan II faces upwards.

10. The simulated three-dimensional flame apparatus according to claim 1, wherein: the mist generation mechanism comprises an atomization sheet disposed in the mist accumulation chamber, a water absorbing stick and a water storage tank disposed at the bottom of the base; one end of the water absorbing stick extends into the water storage tank and another end is connected to the atomization sheet.

11. The simulated three-dimensional flame apparatus according to claim 1 or 6, wherein: The light emitting mechanism is a light source disposed at the side of the flame outlet. When operating, the light beam from the light source at the side radiates on the mist emitted from the flame outlet.

12. The simulated three-dimensional flame apparatus according to claim 11, wherein: The light source is two or more multi-colored light sources that emit light in a color-changing manner. When operating, the color-changing light beam emitted from the light sources radiates on the mist emitted from the flame outlet.

13. The simulated three-dimensional flame apparatus according to claim 11, wherein:
The light source is two or more light sources that emit light by alternating light and dark. When operating, the light beam alternating light and dark that is emitted from the light sources radiate on the mist emitted from the flame outlet.

14. The simulated three-dimensional flame apparatus according to claim 1 or 6,
wherein: it further comprises an electric control board disposed with a power supply; the electric control board is connected to the light emitting mechanism and mist generation mechanism, respectively.

15. The simulated three-dimensional flame apparatus according to claim 14, wherein:
it further comprises a power socket and push button switch; the power socket and push button switch are connected to the electric control board, respectively.
